(19) United States
(12) Patent Application Publication
(10) Pub. No.: US 2022/0192369 A1
(43) Pub. Date: Jun. 23, 2022

(54) FURNITURE, A METHOD FOR ASSEMBLY AND COUPLERS THEREFOR

(71) Applicant: KETER LUXEMBOURG SARL, Niedercorn (LU)

(72) Inventor: Eran MESSALEM, Tel Aviv (IL)

(73) Assignee: KETER LUXEMBOURG SARL, Niedercorn (LU)

(21) Appl. No.: 17/310,513

(22) PCT Filed: Feb. 2, 2020
(86) PCT No.: PCT/IL2020/050122

§ 371 Date: Aug. 6, 2021

(30) Foreign Application Priority Data
Feb. 6, 2019 (IL) 264691

(51) Int. Cl. A47B 47/00; A47B 96/06; F16B 12/46; F16B 12/50

(52) U.S. Cl. CPC A47B 47/0058; A47B 96/066; F16B 12/50; F16B 12/46; A47B 96/068

(57) ABSTRACT

The presently claimed subject matter concerns modular furniture. More specifically the presently claimed subject matter concerns modular furniture, a method for its assembly and couplers therefor.

### TECHNOLOGICAL FIELD

The present disclosure concerns modular furniture. More specifically the disclosure concerns modular furniture, a method for its assembly and couplers therefor.

### BACKGROUND ART

References considered to be relevant as background to the presently disclosed subject matter are listed below:
JP3131011U
US 2005/079010
U.S. Pat. No. 3,966,340
JP6209180
U.S. Pat. No. 5,765,263

Acknowledgement of the above references herein is not to be inferred as meaning that these are in any way relevant to the patentability of the presently disclosed subject matter.

### BACKGROUND

JP3131011U discloses a cabinet having a pair of side plates, top plate, bottom plate and back plate and a main body, a door provided on a front side of its body, and a lock mechanism for locking the door, having one or more of repositories.

US 2005/079010 discloses a mechanical connector, including a male portion and a female portion, that are adapted to quickly and easily connect and disconnect to and from each other while providing for a secure and tight-fit connection that is able to pass lateral force there through. The male portion includes a base having a mating surface, a first locking member having one or more outwardly protruding lugs, and a guide rod. The female portion includes a base having a mating surface and an aperture, a second locking member in the form of a cavity, and a bore adapted to accept the guide rod. Rotation of the male and female portions relative to each other causes the first and second locking members to securely engage, which forces the bases of the male and the female portions together and to be locked in place to form the secure connection.

U.S. Pat. No. 3,966,340 discloses a twist lock connector for use in connecting and disconnecting components, such as knock-down furniture components, and being characterized by a construction which provides easy selective progressive friction locking and unlocking thereof to a selected degree by opposite relative right-hand or left-hand rotation of a correlated amount.

JP6209180 discloses a storage furniture comprising a back plate attached to a wall surface of a building, side plates, bottom plates, top plates and a plurality of movable shelf plates detachably disposed to each of the side plates, the storage furniture including a rectangular box-like furniture body with a front side thereof opened. The furniture body supports the back plates, and includes support members made of a plate material and installed from the back side so as to be provided above the bottom plates and extending along the wall surface of the building in a left-right direction. On a top face of the support members there is provided a shelf palate placing part on which the movable plates removed from each of the side plates can be placed in a vertically standing state.

U.S. Pat. No. 5,765,263 discloses a door positioning hinge supporting two closure members, and allowing the closure members to be rotated to open or close. The door positioning hinge can be adapted to allow free-swinging of the closure members or alternatively to hold the closure members in various detent positions. In addition, the particular amount of force can be selected where desired to hold the closure members in the respective detent positions. The operation of the door positioning hinge accommodates use with both vertically swinging or horizontally swinging closure members.

### GENERAL DESCRIPTION

A first aspect of the present disclosure is directed to a modular furniture system comprising a frame assembly and a shelf assembly; the frame assembly comprises a right side wall, a left side wall, a top wall and a bottom wall; a corner coupler disposed at corners of the furniture system and articulating neighboring ends of frame walls; the shelf assembly comprises at least one partition member articulated at least at one end to one of the top wall and the bottom wall; and a plurality of wall couplers configured for coupling at least an end of the at least one partition member to a respective wall.

In the specification, the right side wall and the left side wall are collectively referred to as side walls. The top wall and the bottom wall occasionally are collectively referred to as base walls. The side walls, the base walls the shelves and the partition members are collectively referred to as boards.

A modular furniture system according to the present disclosure comprises a frame assembly and a shelf assembly; the frame assembly comprising a right side wall, a left side wall, a top wall and a bottom wall; a corner coupler disposed at corners of the furniture system and articulating neighboring ends of frame walls; the shelf assembly comprising at least one shelf member extending between and articulated to the right side wall and the left side wall, and at least one partition member extending between and articulated to the at least one shelf member and one of another shelf member and the top wall and the bottom wall; a plurality of wall couplers configured for coupling ends of the at least one shelf member and ends of a partition member to a respective wall; and a plurality of partition couplers for coplanar coupling at least one first partition members above a shelf member, and at least one second partition members below said shelf member.

A second aspect of the disclosure is directed to wall couplers used for assembling of modular furniture items, said wall couplers configured for coupling ends of the at least one shelf member to the right side wall and left side wall, respectively, and ends of a partition member to a respective top wall and bottom wall.

A third aspect of the disclosure is directed to partition couplers for coplanar coupling first partition members above a shelf member, and second partition members below said shelf member wall couplers used for assembling of modular furniture items.

A fourth aspect of the disclosure is directed to a method for assembly of modular furniture system comprising a frame assembly comprising a right side wall, a left side wall, a top wall and a bottom wall; and a shelf assembly comprising at least one shelf member and at least one partition member; a plurality of wall couplers configured for coupling ends of the at least one shelf member and ends of a partition member to a respective wall; a plurality of partition couplers for coplanar coupling at least one first partition members above a shelf member, and at least one second partition members below said shelf member and corner couplers for coupling neighboring ends of frame walls; the method comprising the steps of:
a. sub-assembling the right side wall, the left side wall, the top wall and the bottom wall, to comprise each at least a pair of stiffening rods extending therethrough, and a plurality of wall couplers secured to the stiffening rods through openings performed at inside faces of the walls;
b. articulating a corner coupling at respective ends of the right side wall and the left side wall;
c. articulating one or more partition members over the bottom wall and securing over the wall couplers;
d. applying a plurality of partition couplers to a first shelf member and securing it over the partition members of step (c);
e. applying one or more partition members over the shelf member of step (d) and securing over the partition couplers;
f. repeating steps (d) and (e) to complete sub-assembling the shelf assembly with a top wall mounted over top partition members and secured by the wall couplers; and
g. applying the right side wall and the left side wall of step (a) to the top wall, the shelf members and the bottom wall and securing by the wall couplers.

It is appreciated that the order of assembling the sub-assemblies can be altered. For example, steps (a) and (b) can be performed after step (f).

After assembling the modular furniture system, it can be reinforced by fasteners extending through the corner couplings.

The corner coupler can be configured with a first face articulated to and abutting an end face of a first frame wall, and a second face articulated to and abutting an end face of a neighboring, second frame wall, said first face and said second face disposed at a right angle.

According to yet an aspect of the disclosure there is provided a furniture system assembly kit comprising at least: a right side wall; a left side wall; a top wall; a bottom wall; respective reinforcing rods; at least one shelf member; at least two partition members; and a plurality of corner couplers, wall couplers and partition couplers;

Any one or more of the following features designs and configurations can be applied to any one or more of the different aspects of the present disclosure, separately or in various combinations thereof:
The frame assembly of the modular furniture can be polygonal. According to one example, the frame assembly has a rectangular shape. According to another example, the frame assembly has a triangular shape. According to yet an example, the frame assembly has at least a circular portion;
The frame assembly can be a closed, right angled, polygonal shaped frame;
At least one of the right side wall, the left side wall, the top wall, the bottom wall, the shelve members and the partition members may be made of extruded polymeric material;
The right side wall, the left side wall, the top wall, the bottom wall, the shelve members and the partition members may be made of extruded polymeric material;
The walls of the frame assembly, the shelves and partition members of the shelf assembly may be hollow boards (e.g. extruded hollow boards), configured with a plurality longitudinally disposed reinforcing ribs;
The reinforcing ribs of the boards can be symmetrically spaced apart from one another;
The reinforcing ribs of the boards, together with inside faces of the boards, may give rise to a clamping space configured for snugly receiving at least one of: studs of a corner coupler, wall couplers, first partition members, and second partition members;
At least one surface of a board, defining the clamping space, can be configured with a snap-type locking mechanism, configured for snapingly arresting a studs of a corner coupler, or of a wall coupler, or of a partition coupler;
The reinforcing ribs of the boards can be parallelly disposed;
The reinforcing ribs of the boards can extend perpendicular between inside surfaces of the boards;
The clamping space can have a rectangle cross section;
Each of the right side wall, the left side wall, the top wall and the bottom side wall can be configured of a continuous board, or of several right-angled disposed neighboring boards;
At least one stiffening rod can extend through the boards for increasing the bending stiffness thereof;
At least one stiffening rod can extend through at least the right side wall, a left side wall, a top wall and a bottom wall for increasing the bending stiffness thereof;
The at least one stiffening rod can be disposed snugly within clamping space of the boards;
The at least one stiffening rod can be made of extruded material (e.g. polymeric material, metals, reinforced/composite materials);
The at least one stiffening rod can be made of extruded material and having at least one articulation arrangement configured for articulating a wall coupler thereto;
The articulation arrangement can be configured as a coupling groove extending along at least a portion of the stiffening rod, said coupling groove configured with two arresting shoulders, facing each other, and configured for arresting a locking boss of the wall coupler;
Articulation of a side wall to the top wall and the bottom wall, respectively, can be facilitated by a corner coupler comprising side wall stud projections and base wall stud projections disposed at a right angle with respect to said side wall stud projections, said side wall stud projections and base wall stud projections configured for snugly receiving within clamping spaces of the boards;
The frame assembly can be reinforced by fasteners extending through the corner coupler and into the respective side walls and base walls of the frame assembly;
Openings at an outside surface of the corner coupler, facilitating insertion of fasteners, can be concealed by concealing caps;
The openings at an outside surface of the corner coupler can facilitate articulating a coupler element thereto, configured for attaching the furniture system to a support wall or to a neighboring furniture item;
The wall coupler can comprise a T-shaped engaging head configured for engagement by arresting shoulders of a coupling groove of a reinforcing rod;
The wall coupler can comprise a body portion configured for snug accommodation within a with a clamping spaces of the boards;
The body portion of the wall coupler can be bifurcated for accommodation within two neighboring clamping spaces of the boards;
The body portion of the wall coupler can be configured with a snap arrangement for arresting within a clamping space of the board;
The body portion of the wall coupler can be configured with a bore for securing to the reinforcing rod by a screw-fastener; said screw fastener extending from a hollow in the body portion and through the T-shaped engaging head;
The partition coupler can comprise a male member and a female member coaxially couplable with one another through an intermediate board clamping portion, wherein one of the male member and female member is configured to upright project from a first surface of a shelf member, and the other one of the male member and female member is configured to upright project from a second surface of a shelf member;
The male member and the female member of the partition coupler can be couplable with one another by a bayonet coupling;
The bayonet coupling can comprise a plug member extending from one of the male member and the female member and fitted with at least one laterally projecting locking lug, configured for coaxial arresting within a cup shaped portion of the other one of the male member and the female member, configured in turn with an axial insertion path and arresting recesses for snapingly arresting the at least one locking lug;
The intermediate board clamping portion can be cylindrical and have a nominal diameter corresponding with an opening extending thorough the shelf member;
A length of the intermediate board clamping portion can be similar to the thickness of the shelf member;
A length of the intermediate board clamping portion can be slightly less than the thickness of the shelf member, whereupon coupling the male member and the female member clamps the shelf member therebetween and applies a squeezing force normal to a surface of the shelf member;
One or both of the male member and the female member can be configured with a fastener bore intersecting a longitudinal coupling axis of the partition coupler;
The fastening bore can facilitate securing the respective male member and female member within the clamping space of the partition member;
The fastening bore can facilitate for securing auxiliary elements to the modular furniture, such as back wall panels, wall securing hooks, basket and drawer rails, doors, and the like.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a perspective view of an assembled 4×4 modular furniture system, according to an example of the present disclosure;

FIG. 2 is an exploded view of the furniture system of FIG. 1;

FIG. 3A is a subassembly of a side wall of the furniture system of FIG. 1;

FIG. 3B is subassembly of a top/bottom wall of the furniture system of FIG. 1;

FIG. 3C is subassembly of a shelf member of the furniture system of FIG. 1;

FIG. 4A is a perspective view of a reinforcing rod of the cup furniture board system;

FIG. 4B is an end view of an example of the reinforcing rod of FIG. 4A;

FIG. 4C is an end view of another example of the reinforcing rod of FIG. 4A;

FIG. 5A is a perspective view of a wall coupler according to the disclosure:

FIG. 5B is a first side view of the wall coupler of FIG. 5A;

FIG. 5C is a second side view of the wall coupler of FIG. 5A;

FIG. 5D is a section along line V-V in FIG. 5C;

FIGS. 6A to 6C illustrate consecutive steps of articulating a wall coupler to a side/base wall;

FIG. 6D is a top, sectioned view of a wall coupler articulated to a side/base wall;

FIG. 6E is a top, sectioned view of a wall coupler articulated to a side/base wall with a reinforcement screw attached;

FIG. 7A is a perspective view of another embodiment of a wall coupler according to the disclosure;

FIG. 7B is an exploded local view illustrating employment of a wall coupler according to FIG. 7A;

FIG. 7C is a partially translucent view, illustrating the wall coupler of FIG. 7A at an assembled position;

FIG. 7D is a section along line VI-VI in FIG. 7C;

FIG. 7E is a section along line VII-VII in FIG. 7C;

FIG. 8A is a perspective view of an assembled partition coupler according to an embodiment of the disclosure;

FIG. 8B is a sectioned view of the partition coupler, taken along line VIII-VIII in FIG. 8A;

FIG. 8C is a sectioned view of the partition coupler, taken along line IX-IX in FIG. 8A;

FIG. 9A to 9F are respective views of a male member of the partition coupler of FIGS. 8A-8C;

FIGS. 10A to 10E are respective views of a female member of the partition coupler of FIGS. 8A-8C;

FIGS. 11A and 11B illustrate consecutive steps of articulating the partition coupler through a shelf;

FIG. 11C is a section through line XI-XI in FIG. 11B;

FIG. 11D illustrates the partition coupler superimposed mounted through a shelf member;

FIG. 12A is an external perspective view of a corner coupler according to an embodiment of the disclosure;

FIG. 12B is a perspective inside view of the corner coupler of FIG. 12A;

FIG. 12C is an enlarge view of a fastener portion of the corner coupler of FIG. 12A;

FIG. 12D is a side view of an embodiment of a corner coupler, configured with a wall securing eye;

FIG. 13A illustrates an articulating eye attached to a corner coupler according to the disclosure;

FIGS. 13B and 13C are inside and outside perspective views of a concealer cover configured for concealing apertures of the corner coupler;

FIG. 14 is an exploded perspective view of the furniture system, at a sub-assembled position;

FIG. 15A to 15H illustrate consecutive steps of assembling the furniture system illustrated in FIG. 1;

FIG. 16A illustrates the cupboard of FIG. 1, fitted with several back panels;

FIG. 16B is an enlargement of a back portion of the furniture system of FIG. 16A;

FIG. 16C is an enlargement of the back cover seen in FIG. 16A;

FIG. 16D is an enlargement of the portion marked XVI in FIG. 16B, illustrating a wall securing eye;

FIG. 17A to 17E illustrate optional fastening of partition members to a wall coupler and optional securing thereto of a wall fastener;

FIG. 18A to 18E illustrate optional fastening of partition members to a partition coupler and optional securing thereto of a auxiliary elements;

FIG. 19A is a planar representation of another example of a modular furniture system according to the disclosure; and

FIGS. 19B and 19C are enlargements of the portions marked 19B and 19C, respectively, in FIG. 19A.

### DETAILED DESCRIPTION OF EMBODIMENTS

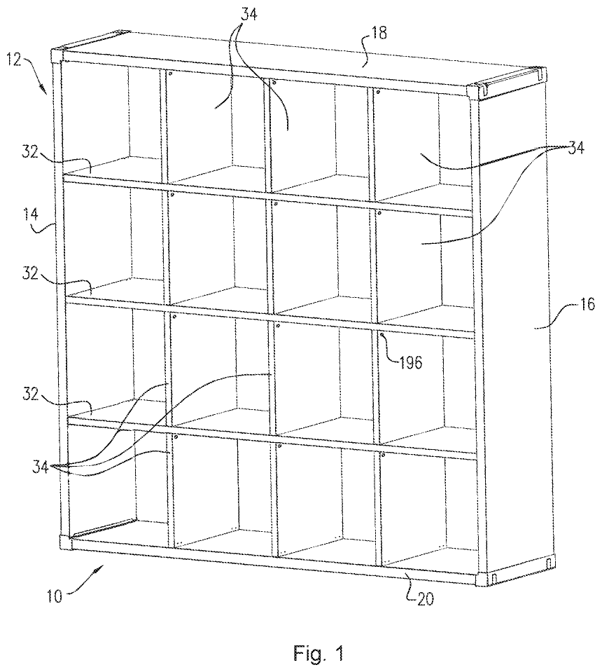

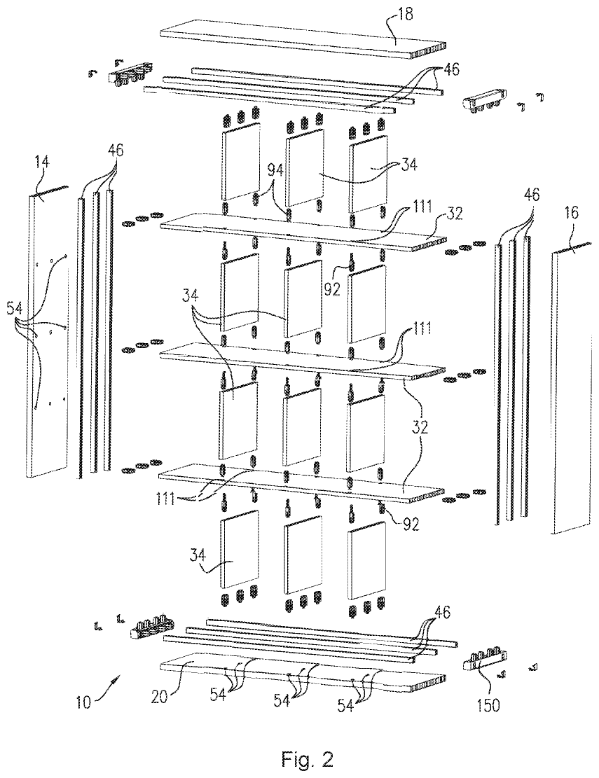

Attention is first directed to FIG. 1 of the drawings, illustrating an exemplary modular furniture system generally designated 10, compartmented as a 4×4 shelving system, having a closed, right angled, polygonal shaped frame (rectangle in the illustrated example). It is appreciated that the illustrated system is a mere example and the modular furniture system can assume a different number of shelves and partitions, and may have assume different overall shape.

The system 10 comprises a frame assembly generally designated 12, comprising in turn a right side wall 14, a left side wall 16 (the two walls 14 and 16 collectively referred to as side walls), a top wall 18 and a bottom wall 20 (the two walls 18 and 20 collectively referred to as base walls), and wherein the side walls and the base walls are collectively referred to as boards.

The system 10 further comprises a shelf assembly, which in the present example comprises three parallelly disposed shelf members 32 (spanning between the side walls) and twelve partition members 34, normally extending between the neighboring shelve members 32 and between the shelve members and the respective top wall 18 and bottom wall 20.

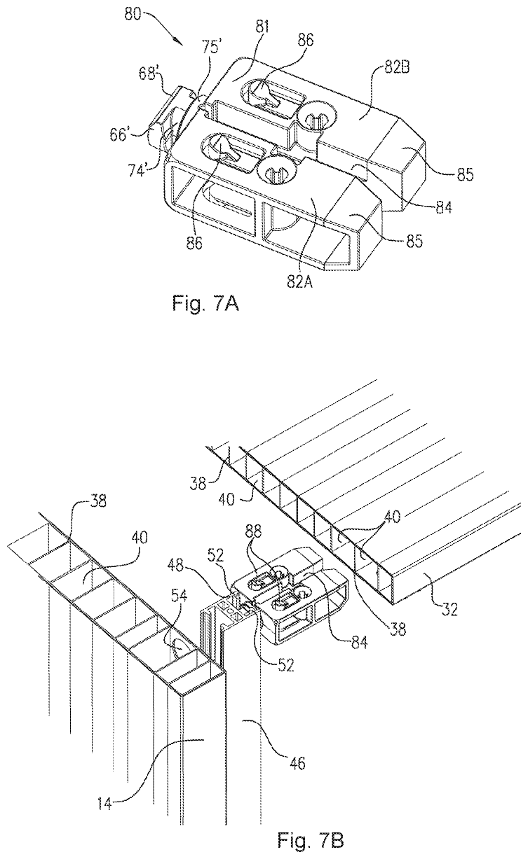

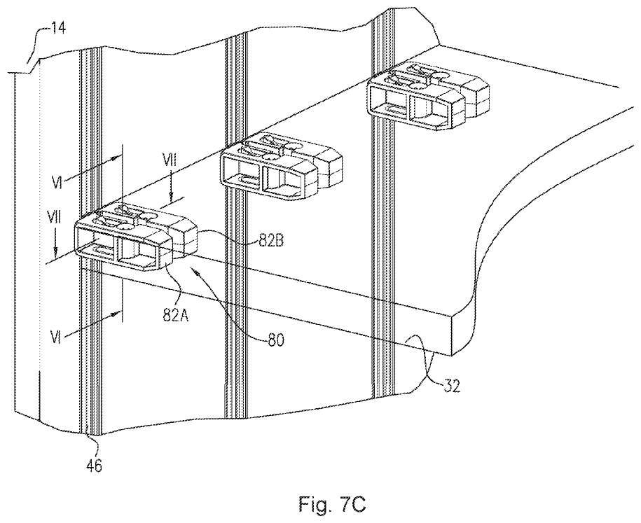

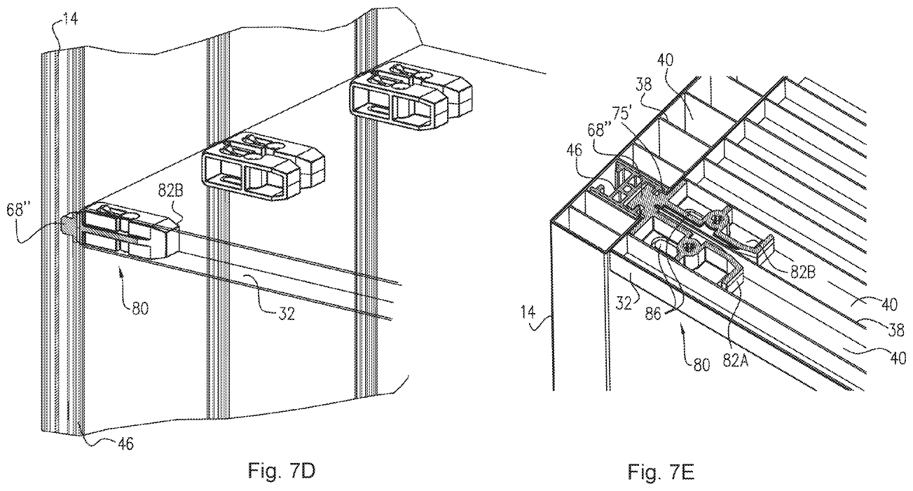

The boards of the frame assembly 12 are made of extruded polymeric material, configured with a plurality of reinforcing ribs 38 (e.g. seen in FIGS. 7B, 7E), said reinforcing ribs 38 extending substantially perpendicular between inside surfaces of the boards, and giving rise to a plurality of clamping spaces 40 having a rectangle cross section. The reinforcing ribs 38 can be equally spaced apart, thus giving rise to equally shaped and sized clamping spaces 40, or the reinforcing ribs 38 can be unequally spaced, however with predefined locations of standardized clamping spaces 40.

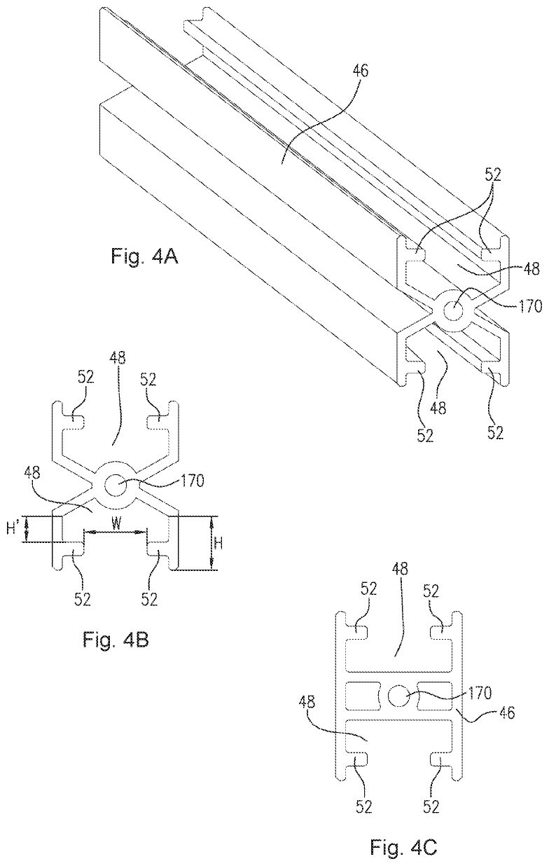

The side walls 14 and 16, and the base walls 18 and 20 are reinforced by three reinforcing rods 46, parallelly extending throughout the length of the respective clamping spaces 40 of the boards. It is appreciated that according to other examples, the boards can be reinforced by two or more reinforcing rods. The reinforcing rods 46 are made of polymeric material (e.g. of PVC) or of reinforced material (e.g. composite material) or metal, and are configured with a cross section designed for increased bending stiffness, as can be seen, by way of example, in FIGS. 4B and 4C. The cross section of the reinforcing rods 46 is configured for snug insertion within the clamping spaces 40 of the boards, and is designed with a coupling groove 48 configured with two arresting shoulders 52, facing each other.

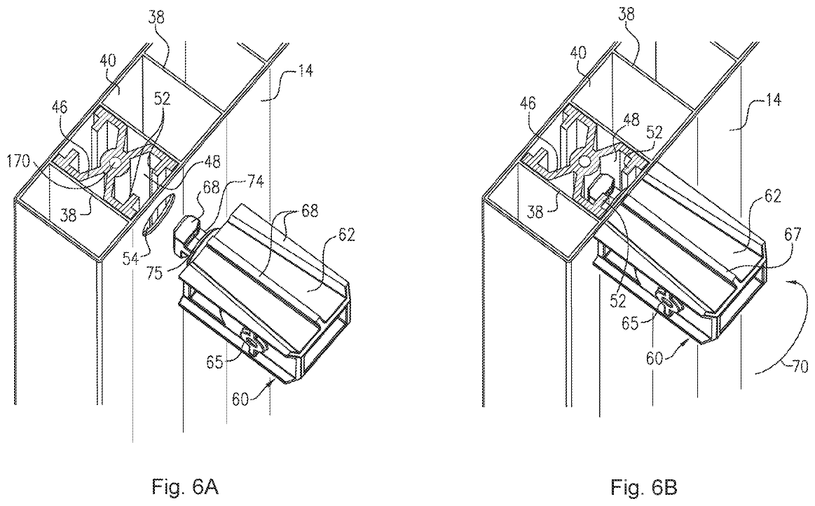

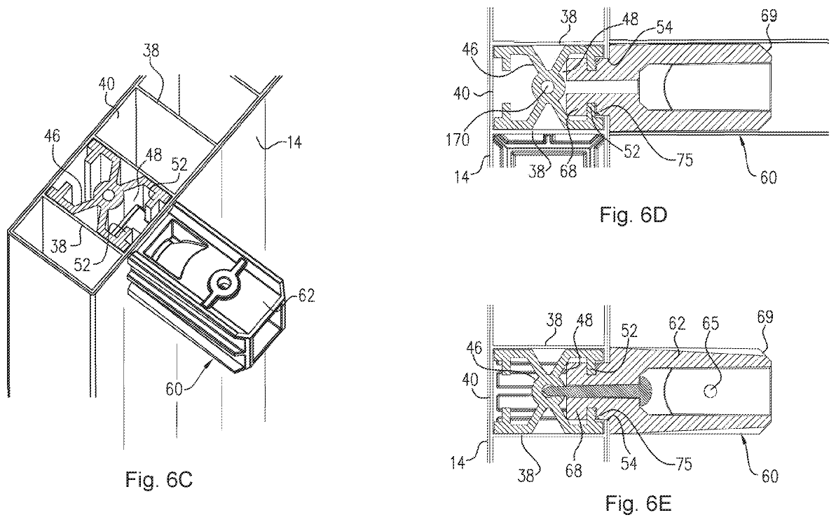

An inside wall of the boards, namely of side walls 14 and 16 and base walls 18 and 20, are each configured with a plurality of spaced apart openings 54, disposed in horizontal pairs. The openings are disposed in register with the grooves 48 of the reinforcing rods 46 (FIGS. 6A to 6E).

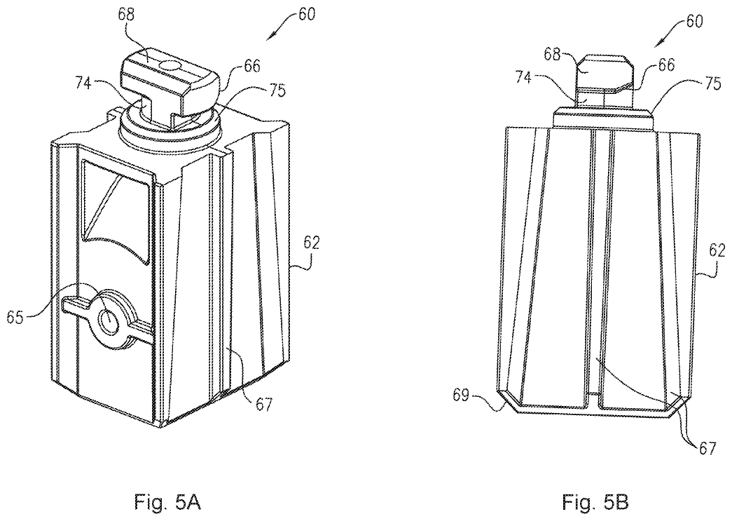

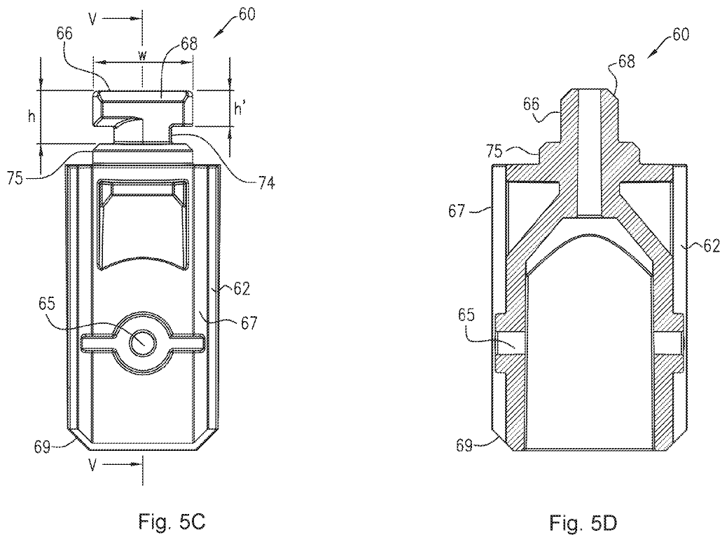

The furniture system further comprises a plurality of wall couplers, generally designated 60 (FIGS. 5A to 5D). Each wall coupler 60 is configured with a body portion 62 and a T-shaped engaging head 66. The body portion has a cuboid-like shape and is configured with friction ribs 67 for snug fitting with a respective clamping space 40 of the side walls 14 and 16, and the base walls 18 and 20. The body portion 62 is further configured with a fastener receiving bore 65 (whereby a fastener can be screw fastener or a snap articulating member extending from a shelf member or from a partition member, as will be discussed hereinafter). Also noted, bottom edges of the body portion are chamfered at 69, to facilitate easy insertion into a clamping space 40.

The T-shaped engaging head 66 projects from a top end of the body, having a neck portion 74 with a maximal inscribing diameter being slightly less than the distance between the two facing arresting shoulders 52 of the reinforcing rods 46, and wherein the maximal height h of the head portion (FIG. 5C) is slightly less than the height H (FIG. 4B) of the groove 48, as measured from the surface of the reinforcing rods 46. The widened head portion 68 of the engaging head 66 has a height h′ being slightly less than the height of space H′ of the groove 48 of the reinforcing rods 46, to facilitate locking engagement as will be discussed hereinafter also with reference to FIGS. 6A to 6E. The maximal width W of the widened head portion 68 is slightly less than the distance w between the two facing arresting shoulders 52 of the reinforcing rods 46, whereby the widened head portion 68 can be inserted through the gap between the two facing arresting shoulders 52 at a so-called insertion position, and then rotated by 90° into a so-called locked position, wherein the widened head portion 68 becomes arrested within the groove 48, behind the arresting shoulders 52. The maximal width W of the widened head portion 68 is slightly less than the diameter of openings 54 formed in the boards (side walls 14 and 16, and the base walls 18 and 20).

The wall couplers 60 are configured, flush with the body portion 62 and intermediate the neck portion 74 with a cylindrical projection 75, the diameter of which corresponds with the diameter of openings 54 formed in the inside face of boards (side walls 14 and 16, and the base walls 18 and 20), such that at an assembled position the cylindrical projection 75 is snug within the opening for correct positioning thereof and for imparting some of the loads to the boards.

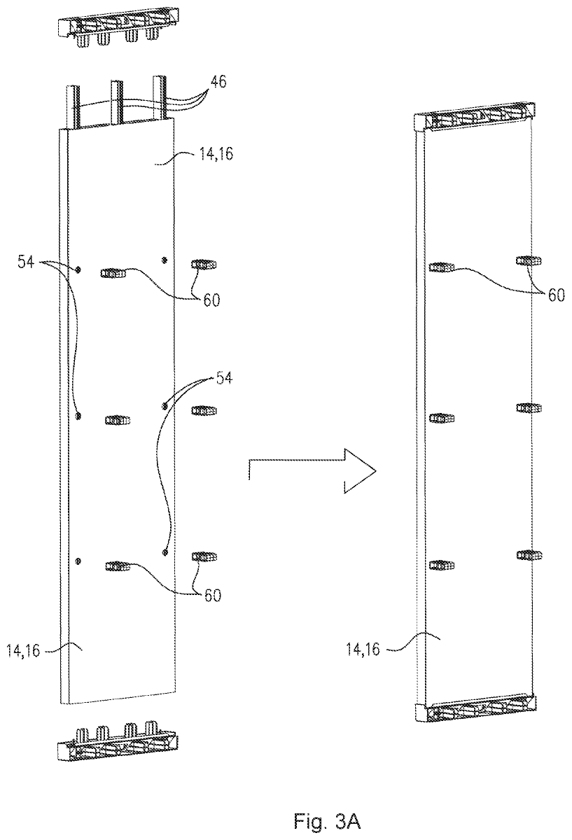

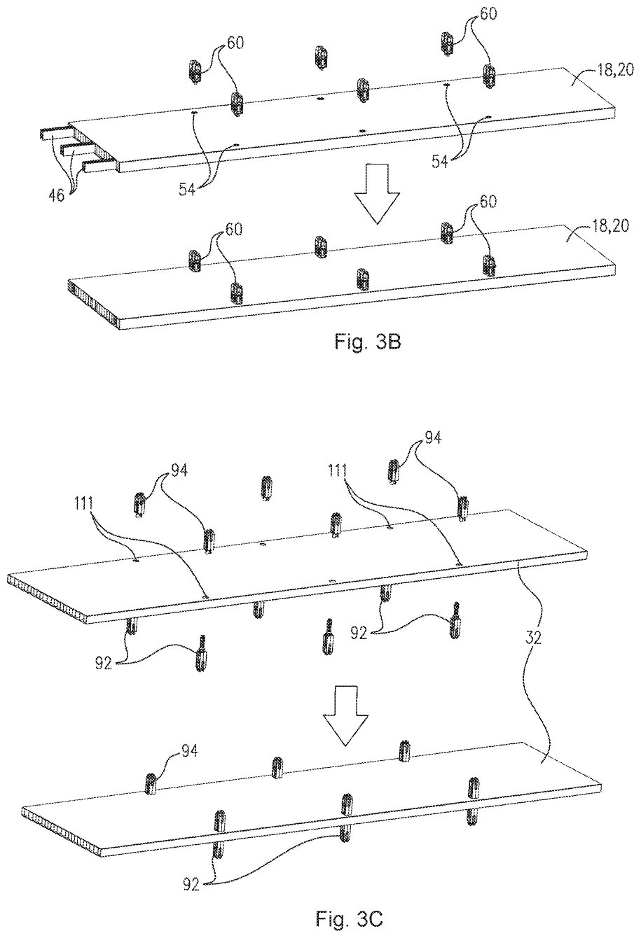

A first step of sub-assembling the frame assembly 12 comprises snugly inserting the reinforcing rods 46 into the respective clamping spaces 40 of the side walls 14 and 16 (FIG. 3A), and the base walls 18 and 20 (FIG. 3B). At their assembled position the reinforcing rods 46 extend between the respective ends if each of the boards, and do not project therefrom.

A second step of sub-assembling the frame assembly 12 comprises articulation of the wall couplers 60 as illustrated in FIGS. 6A to 6E, wherein the widened head portion 68 of a wall coupler 60 is inserted through an opening 54 in the respective board, at the insertion position (FIGS. 6A and 6B) wherein the widened head portion is parallel to the longitudinal axis of the reinforcing rod. Then, upon insertion of the widened head portion, the wall coupler 60 is rotated by 90° (arrow 70 in FIG. 6B) into the locked position (FIGS. 6C to 6E) such that the widened head portion 68 engages with the reinforcing rod 46, as it becomes arrested within the groove 48, behind the arresting shoulders 52, thus preventing axial displacement (detaching) of the wall coupler 60 from the board.

With further reference to FIGS. 7A to 7E, there is illustrated a modification of a wall coupler 80, configured with a bifurcated body portion comprising two body cuboids 82A and 82B with a gap 84 therebetween. The body portion is shaped and sized such that it is configured for inserting each of body cuboids 82A and 82B within one of neighboring clamping spaces 40 of a board, at a snug-fit arrangement, with the gap 84 accommodating the reinforcing rib 38. The body portion is also chamfered at its bottom, insertion end 85, and comprises, at each of the body cuboids 82A and 82B a snap lock 86 which in use is configured for snap arresting by an aperture (schematically marked as 88 in FIG. 7B) configured in register at the respective shelf member 32. The snap lock 86 can facilitate merely as a friction enhancing arrangement against an inside. The wall coupler 80 comprises an engaging head 66′, similar to that disclosed hereinabove in connection with reference to FIGS. 5A-6E, and wherein like element are designated with same reference numbers, with a “′” indication. Thus, the engaging head 66′ is configured with a widened head portion 68′ extending from a neck portion 74′ and apart for the difference in the shape of the body portion, the wall coupler 80 cooperates and couples to a reinforcing rod of a board exactly in the same manner as discussed.

Similarly to the previous example, the wall couplers 80 are configured, flush with a head portion 81 of the body portion and intermediate the neck portion 74′ with a cylindrical projection 75′, the diameter of which corresponds with the diameter of openings 54 formed in the inside face of boards (side walls 14 and 16, and the base walls 18 and 20), such that at an assembled position the cylindrical projection 75′ is snug within the opening for correct positioning thereof and for imparting some of the loads to the boards.

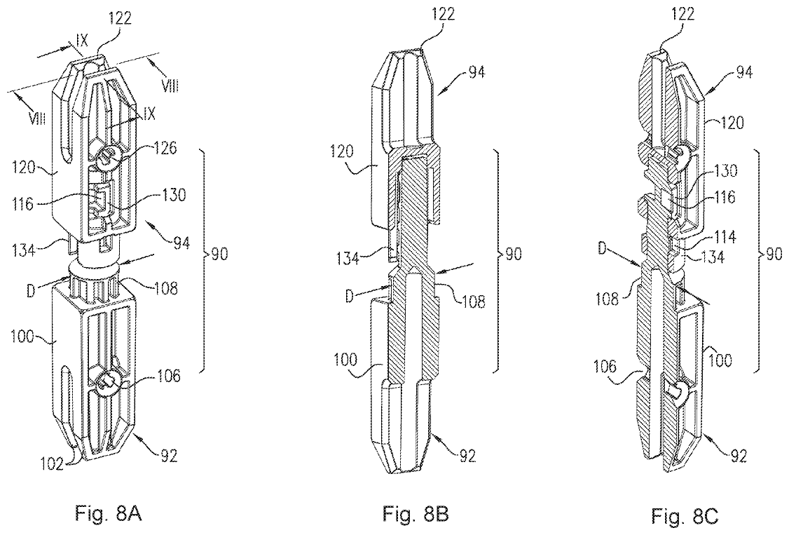

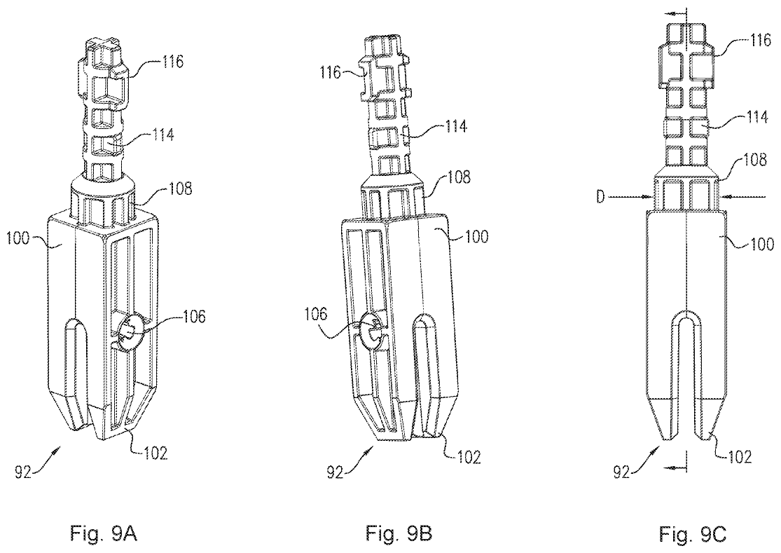

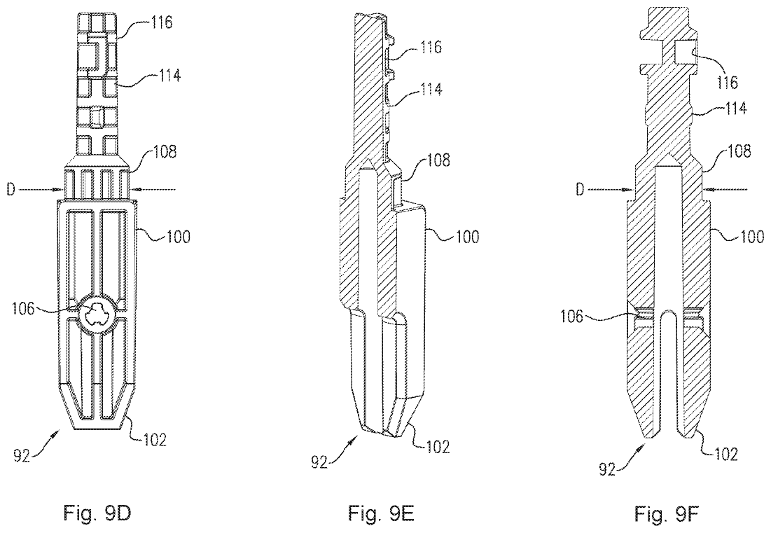

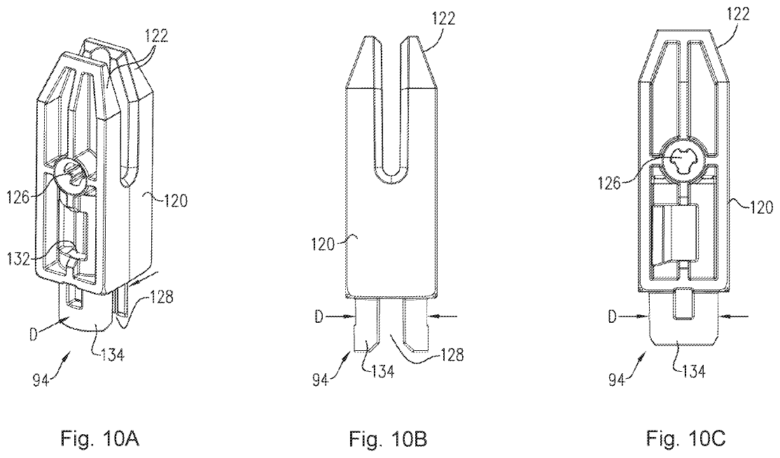

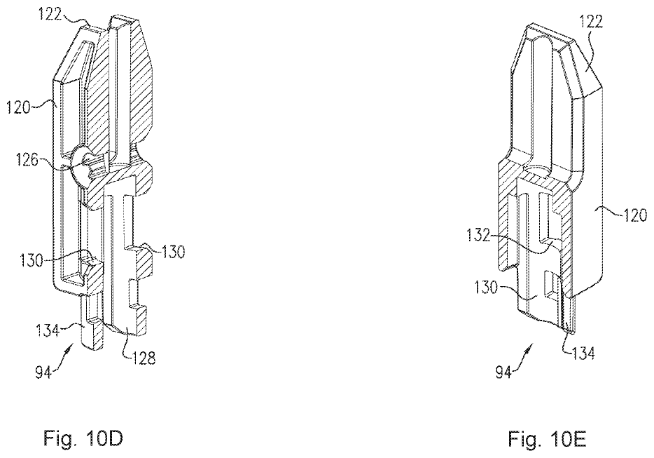

Turning now to FIGS. 8A-11D, there is illustrated a partition coupler according to an aspect of the disclosure generally designated 90, and comprising a male member 92 and a female member 94. The male member 92 comprises a bifurcated body portion 100 having a cuboid-like shape with a chamfered insertion end 102. The shape and size of the body portion 100 is configured for snug insertion into a clamping spaces 40 of a partition member 34, and is further configured with a fastener opening 106 for securing a screw fastener as will be discussed later. Coaxially projecting from the body portion 100 there is a male cylindrical intermediate board clamping portion 108 having a nominal diameter D corresponding with the diameter d of an opening 111 extending thorough the shelf member 32. A plug member 114 extending upwards from the male cylindrical intermediate board clamping portion 108 is fitted with a pair of laterally projecting locking lugs 116.

The female member 94 of the partition coupler 90 also comprises a bifurcated cuboid-like shaped body portion 120, with a chamfered insertion end 122, and a fastener opening 126 for securing a screw fastener as will be discussed later. The shape and size of the body portion 120 being configured for snug insertion into a clamping spaces 40 of a partition member 34.

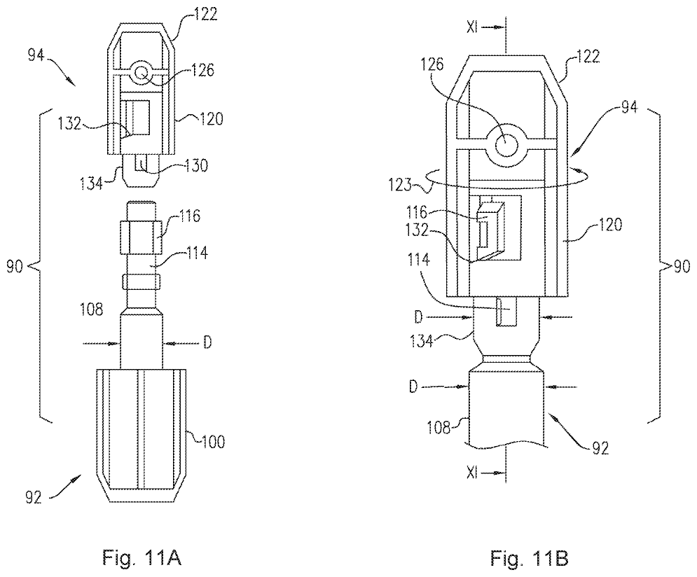

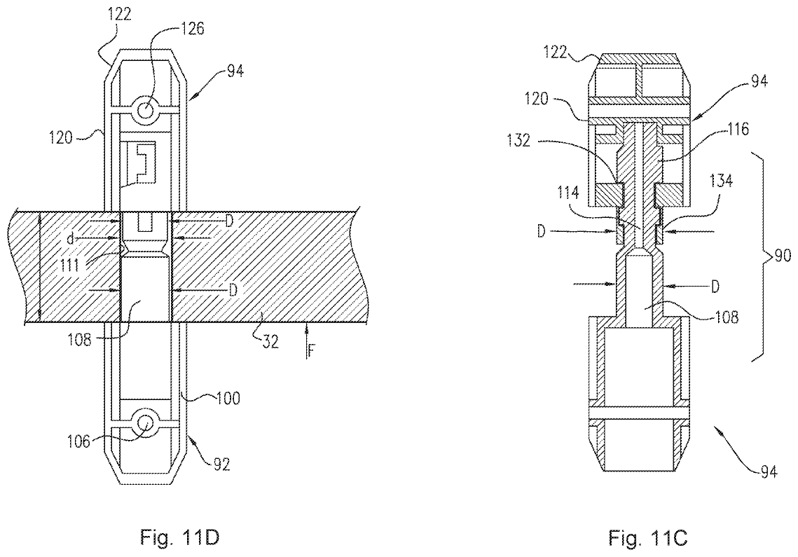

Further, the female member 94 is configured with a cup-like locking portion 128 extending into the body portion 130 with a locking lug arresting surface 132, whereby the male member 92 and the female member 92 of the partition coupler 90 are couplable with one another by a bayonet coupling. The female member 94 is further configured with a cylindrical downward projecting female intermediate board clamping portion 134. The female intermediate board clamping portion 134 has a nominal diameter D corresponding with the diameter d of an opening 111 extending thorough the shelf member 32, and similar to that of the male cylindrical intermediate board clamping portion 108, such that at an interlocked position (FIGS. 11A-11D) the two intermediate board clamping portions 108, 134 co-extend.

It is noted the bifurcated body portion 100, 120 of the male member 92 and the female member 94, respectively, are configured for enhancing snug fitting and tight receiving of the respective body member within a clamping spaces 40 of a partition member 34. However, it is appreciated that either or both of the body portions 100, 120 can just as well be regular cuboid bodies, configured for snug insertion into the clamping spaces 40, with or without friction enhancing arrangements.

The next step of sub-assembly (FIG. 3C) would thus be articulating the partition couplers 90 to the shelf members 32, whereby a male member 92 is inserted into an aperture 111 of the shelf member 32 (e.g. from a bottom face thereof, though the male member 92 and female member are interchangeable in this respect), such that the male intermediate board clamping portion 108 occupies a portion of the aperture 111 through the board 32, and with the plug member 114 projecting through the aperture, above the shelf 32. Than, the female member 94 is coaxially applied over the plug member 114 such that the plug member 114 is received within the cup-like locking portion 128 of the female member 94, whereby the later is rotated by 90° in direction of arrow 123 (FIG. 11B), to obtain bayonet interlocking of the male member 92 with the female member 94, and furtherer whereby the female intermediate board clamping portion 134 bears over the male intermediate board clamping portion 108, in press fit with one another, so as to coextend (FIGS. 11B-11D). It is appreciated that the accumulated length of the intermediate board clamping portions 108 and 134 is similar to the thickness of the shelf 32, or it is slightly shorter, to thereby apply compression force over the opposite faces of the shelf, so as to tightly clamp it i.e. a shelf squeezing force F (FIG. 11D) is applied, normal to a surface of the shelf member.

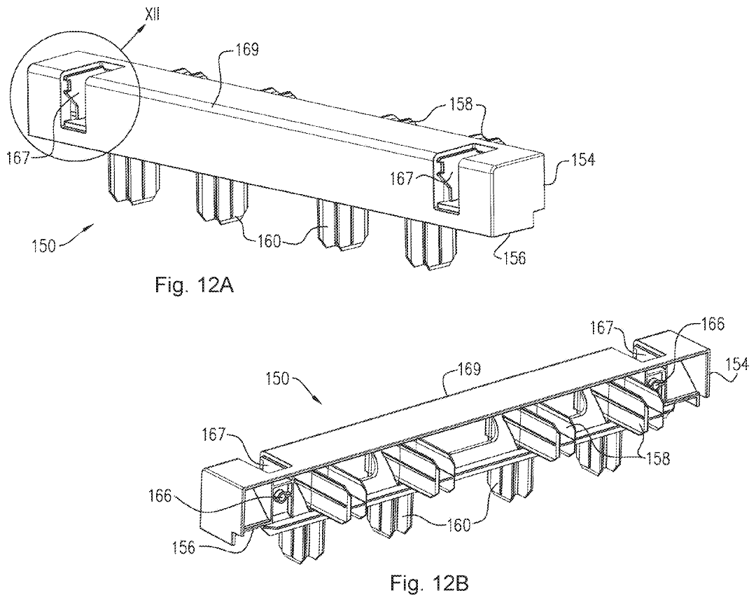

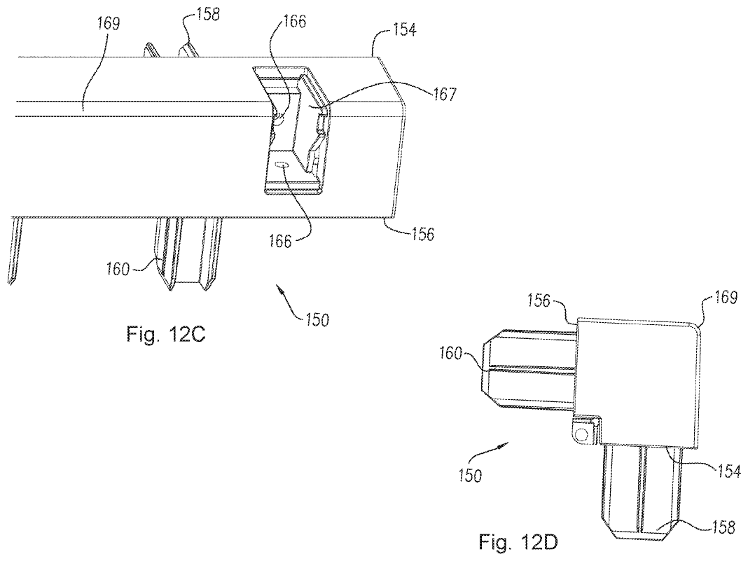

Attaching a side wall (right side wall 14; left side wall 16) to a base wall (top wall 18; bottom wall 20) is carried out by a corner coupler 150 (best seen in FIGS. 12A-12D). The corner coupler 150 is configured with a first face 154 articulated to and abutting an end face of a first frame wall (e.g. one of the right side wall 14 and left side wall 16), and a second face 156 articulated to and abutting an end face of a neighboring, second frame wall (e.g. one of the top wall 18 and the bottom wall 20), wherein said first face 154 and said second face 156 are disposed at a right angle. Projecting from each of the first face 154 and the second face 156 there are a plurality of side wall stud projections 158 and base wall stud projections 160, said stud projections configured for snug insertion into clamping spaces 40 at the ends of the respective boards, to thereby establish rigid corner coupling of the neighboring boards.

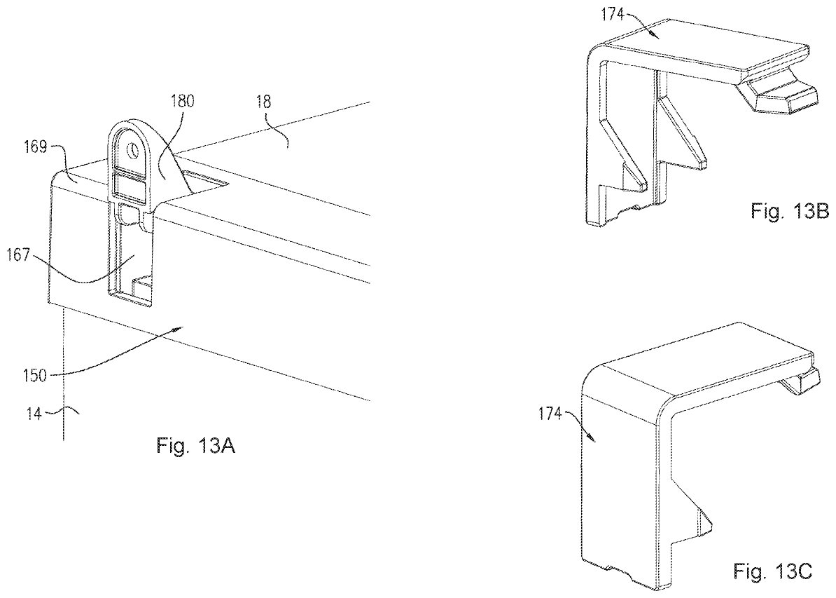

The corner coupler 150 is further configured with two fastener openings 166 extending at cavities 167 at about an outside corner 169 of the corner coupler and through each face 154, 156, said fastener openings 166 extending in registry opposite a center of the respective reinforcing rod 46 of the respective boards, such that a fastener screw 168 can be applied into an axis bore 170 (best seen in FIGS. 4A-4C) of the reinforcing rod 46, in order to secure the corner coupler 150 to the respective boards and rigidify articulation. Once the fastener screws 168 are applied, the cavities are covered by a concealing cover 174 (FIGS. 13A-13C) configured for snapingly arresting into said cavity 167, so as to extend substantially flush with external surface of the corner coupler 150.

As seen in FIG. 13A, instead of a concealing cover 174 there may be applied into the cavity 167 an eye coupler element 180, facilitate articulating attaching the furniture system to a support wall or to a neighboring furniture item (not shown).

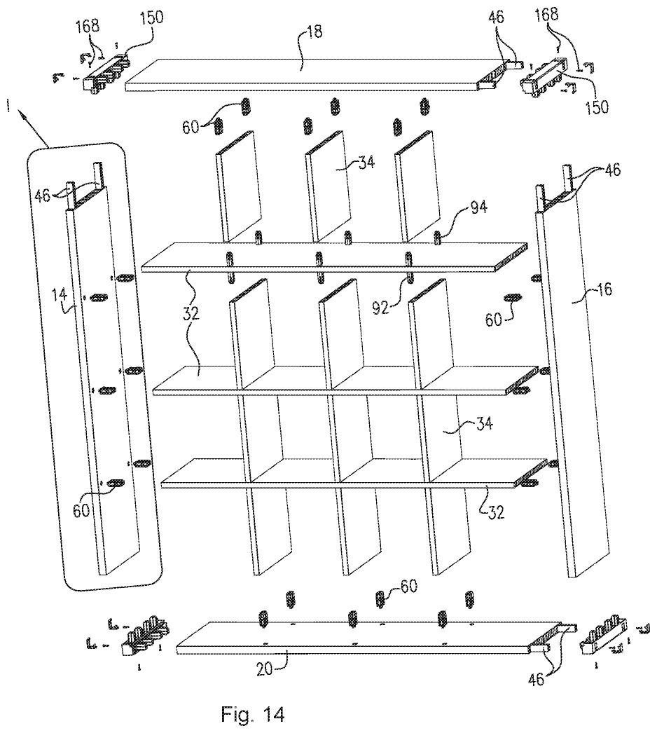

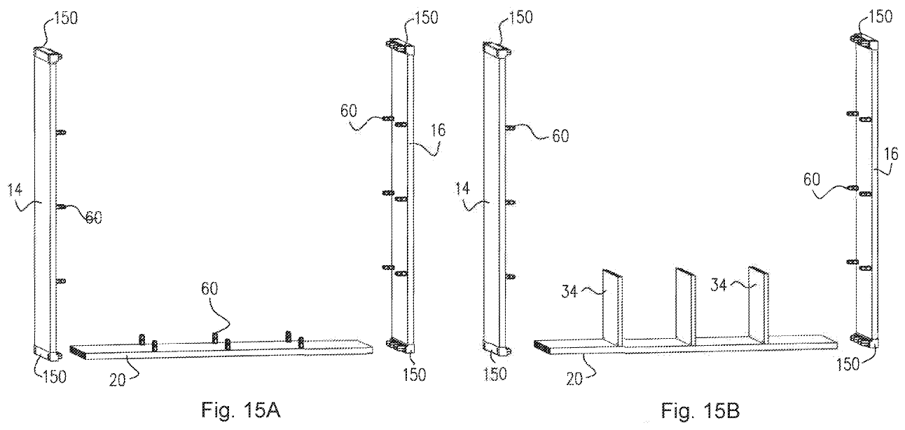

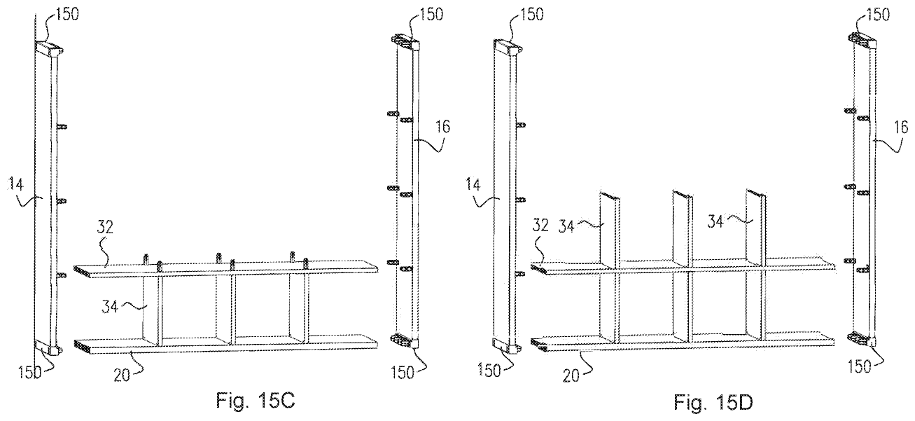

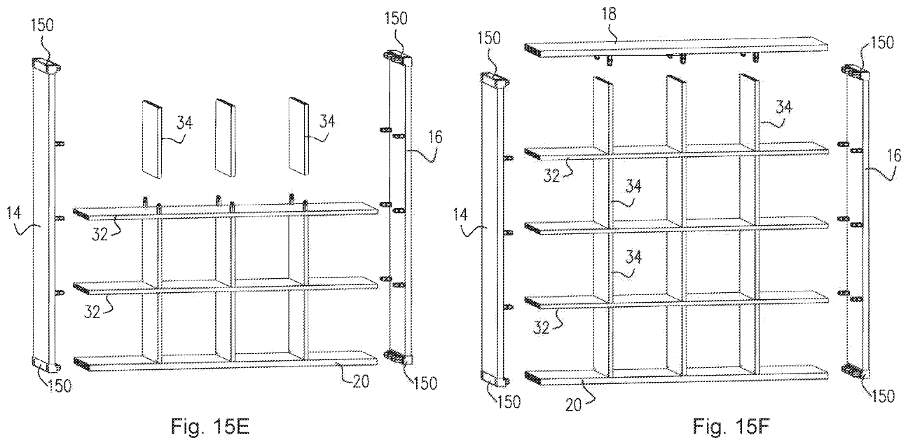

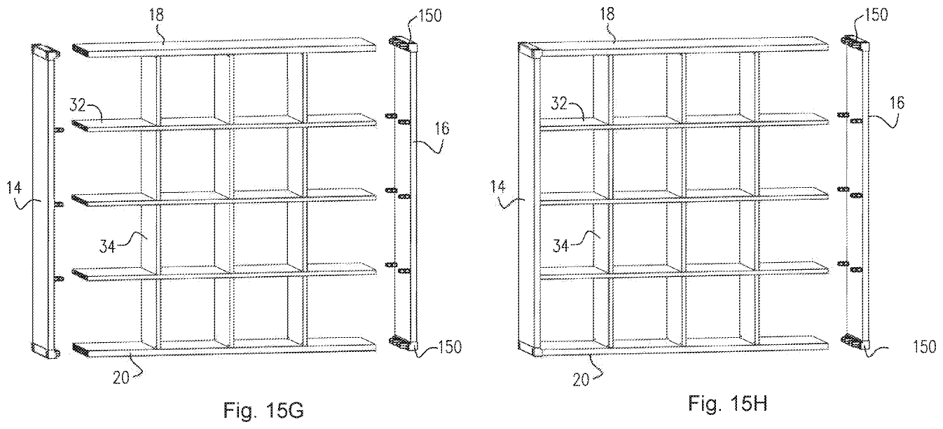

Further attention is now made to FIGS. 14-15H, illustrating steps of assembling the modular furniture system 10.

At a first step, as discussed with reference to FIG. 3A hereinabove, the right side wall 14 and the left side wall 16 are sub-assembled by articulating thereto the reinforcing rods 46, the wall couplers 60, and the corner couplers 150. Further, as discussed with reference to FIG. 3B hereinabove, the top base wall 18 and the bottom base wall 20 are sub-assembled by articulating thereto the reinforcing rods 46 and the wall couplers 60 (FIG. 15A).

Then, the shelf assembly is step by step erected, first by assembling the male and female members (92, 94) of the partition couplers 90 to the shelf members 32, as discussed with reference to FIG. 3C hereinabove.

Following, a first level of partition members 34 and securing them over the wall couplers 60 articulated to the base wall 20 (FIG. 15B). Further, a first shelf member 32 is applied over the first level partition members 34 and secured thereover by the male members 92 of the partition couplers 90, already fitted at the shelf member 32 (FIG. 15C). Consequently, the second level partition members 34 are applied over the first shelf 32 (FIG. 15D), then the second shelf 32 is securely applied over the second level partition members 34 (FIG. 15E) and a third level partition members 34 are applied over the second shelf 32 (FIG. 15E) after which a third shelf 32 is applied as well as forth level partition members 34 (FIG. 15F). After, the top wall 18 is applied over the top level partition members 34 (FIG. 15G) and then, the two side walls 14, 16 are articulated to the shelf assembly (FIG. 15H) by articulation of the corner couplers 150 and securing with the fastener screws as discussed hereinabove, whereby assembly of the system 10 is complete.

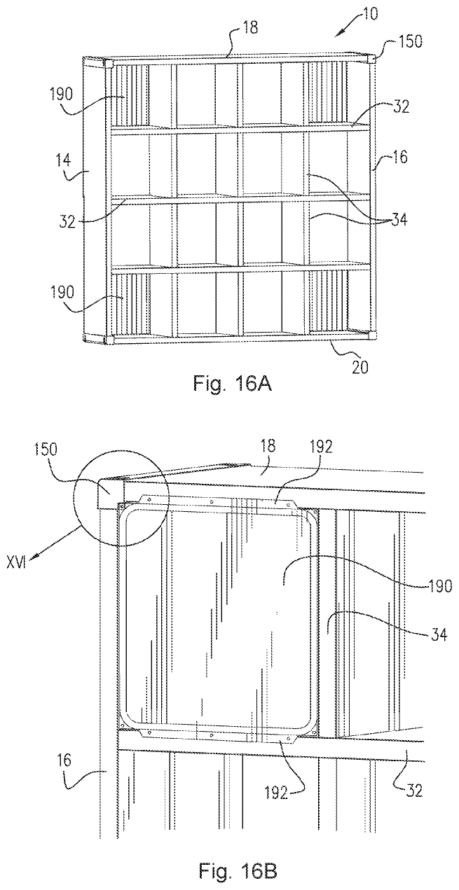

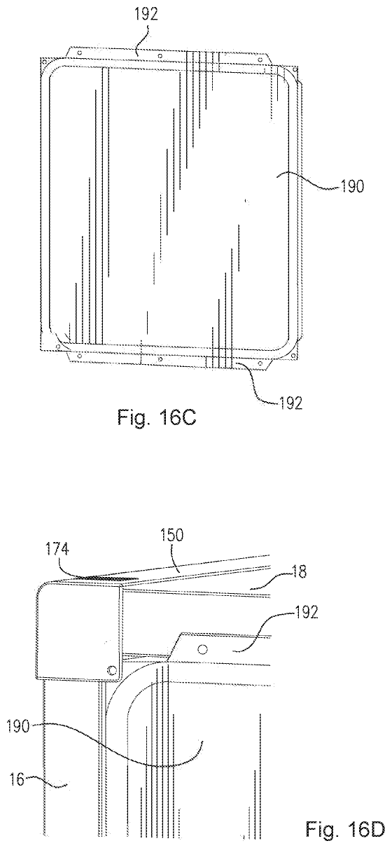

With further reference to FIGS. 16A-16D, there is illustrated a back cover panel 190 having a rectangle shape and configured with side flaps 192 for securing to respective shelf member 32 and/or top or bottom walls (18, 20). The back cover panel 190 can be selectively applied over anyone of the matrix spaces of the cupboard 10.

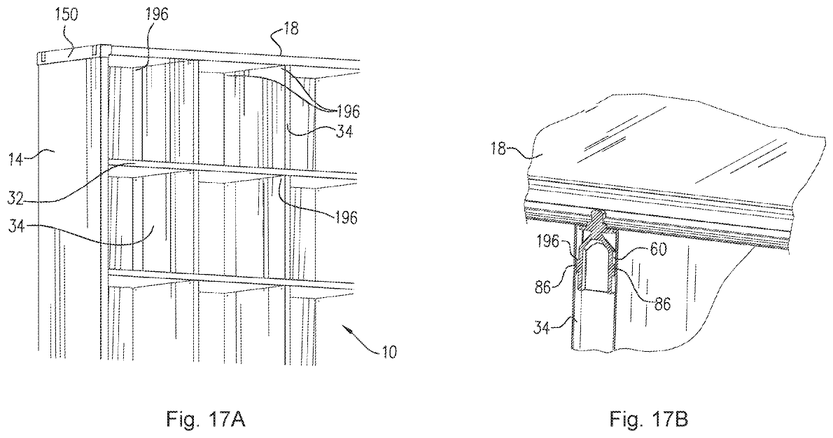

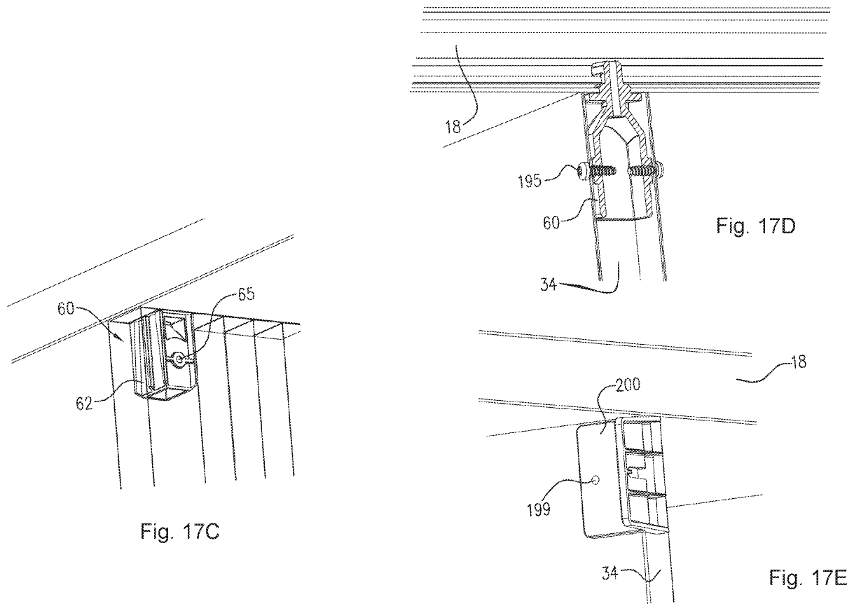

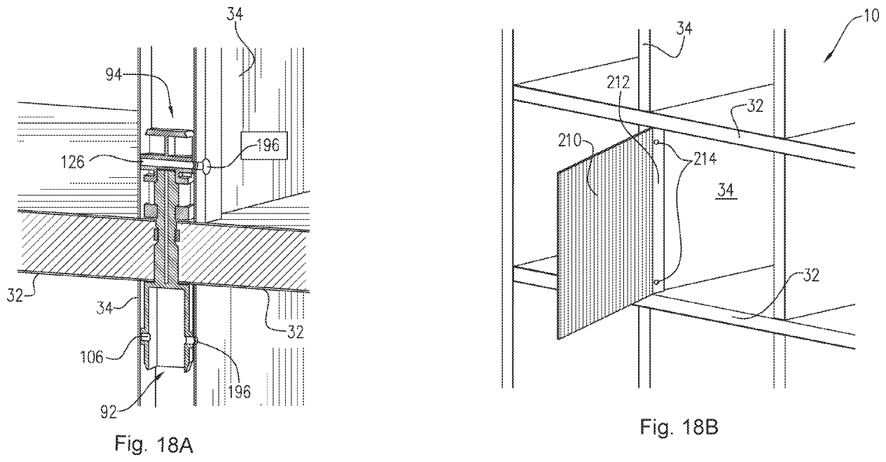

FIGS. 17A-17E illustrate how a fastener screw 195 can be applied through an opening 196 at a surface of the partition member 34, into the fastener receiving bore 65 of wall coupler 60 or a male member 92 or female member 94, for setting the respective coupler body portion within the clamping space 40, for securing same. Alternatively, as illustrated ands mentioned hereinabove, the coupler member can be configured with a resilient snap member 86 configured for snapingly engaging within the board (e.g. opening 196). The fastening arrangement can also be used for applying an L-shaped wall fastener 200 (FIG. 17E), whereby a fastener screw 199 is applied into the wall coupler 60 and facilitates securing the system 10 to a wall (not shown).

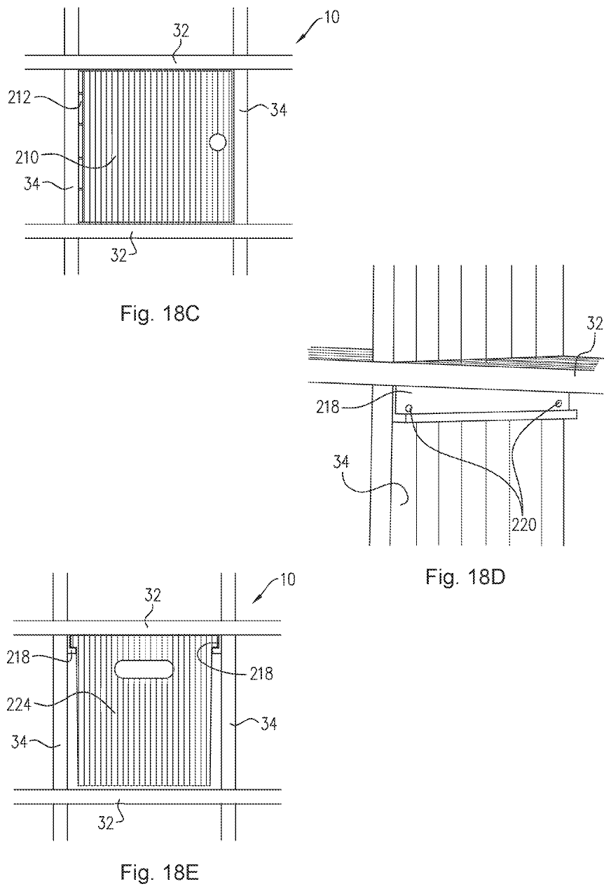

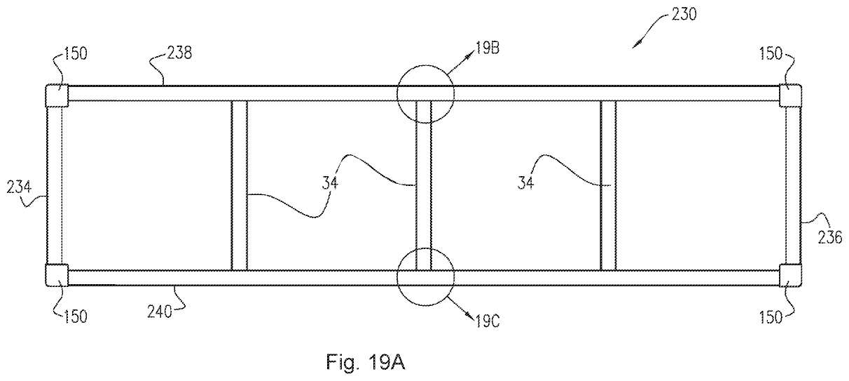

FIGS. 18A-18E illustrates examples of securing auxiliary elements to the modular system 10, by securing elements to intermediate couplers 90. As seen in FIG. 18A the fastener opening 106, 126 of the male member and the female member, respectively, respectively, intersect the longitudinal coupling axis of the partition coupler, wherein said fastener openings can be used for securing the partition member 34 to the respective member of the partition coupler, through openings 196 (FIG. 18A), or for applying thereto a variety of auxiliary elements. In FIGS. 18B and 18C a door 210 is pivotally secured to the partition member 34 by a hinge 212 which in turn is secured to the partition member 34 by screw fasteners 214 secured to the fastener openings 106, 126 of the respective front male member and the front female member. FIGS. 18D and 18E illustrate how a rail system can be applied to a partition wall 34, whereby a pair of L-shaped rails 218 are secured to respective front and rear male members 92 (of a partition coupler), slidingly accommodating a storage container 224.

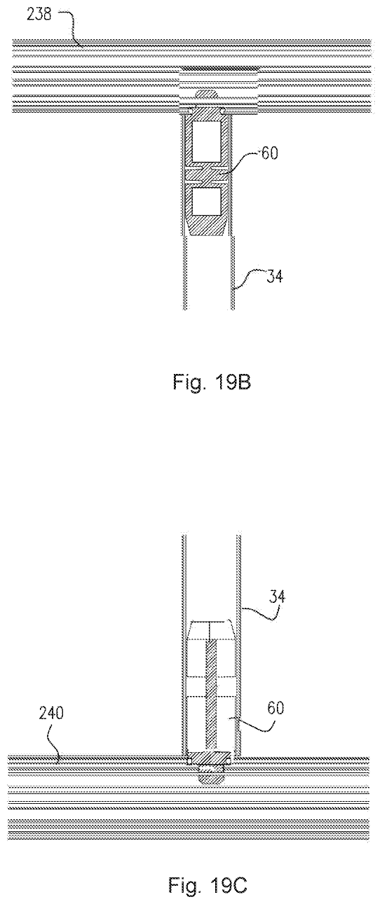

Turning now to FIGS. 19A-19C, there is illustrated a modular furniture system according to another example of the disclosure, being a 1×4 compartmented shelving/cupboard system, generally designated 230. The unit 230 comprises a right side wall 234, a left side wall 236, a top base wall 238 and a bottom base wall 240, said walls coupled to one another by a corner coupler 150 as disclosed hereinabove. The unit 230 is partitioned by three parallelly extending partition members 34 as disclosed hereinabove, said partition members extending between the top base wall 238 and a bottom base wall 240 and articulated thereto by a wall couplers 60, as disclosed herein before. It is noted that the example of FIGS. 19A-19C does not comprise any shelves, whereby articulation of the partition members is facilitated merely by wall couplers 60.

1. A modular furniture system comprising a frame assembly and a shelf assembly;
the frame assembly comprising a right side wall, a left side wall, a top wall and a bottom wall;
a corner coupler disposed at corners of the furniture system and articulating neighboring ends of frame walls;
the shelf assembly comprising at least one partition member articulated at least at one end to one of the top wall and the bottom wall; and
a plurality of wall couplers configured for coupling at least an end of the at least one partition member to a respective wall.

2. The modular furniture system of claim 1, wherein the frame assembly is a closed, right angled, polygonal frame.

3. The modular furniture system of claim 1, wherein the shelf assembly further comprises at least one shelf member extending between and articulated to the right side wall and the left side wall, and wherein the at least one partition member is articulated at least at one end to the at least one shelf member; and wherein ends of the at least one shelf member are coupled to the respective walls by the plurality of wall couplers; and wherein a plurality of partition couplers are provided for coplanar coupling at least one first partition member above a shelf member, and at least one second partition member below said shelf member.

4. The modular furniture system of claim 3, wherein one or more of the right side wall, the left side wall, the top wall, the bottom wall, the shelve members and the partition members are made of extruded polymeric material.

5. (canceled)

6. The modular furniture system of claim 4, wherein the right side wall, the left side wall, the top wall, the bottom wall, the shelve members and the partition members are hollow boards of extruded polymeric material, configured with a plurality of longitudinally disposed reinforcing ribs.

7. The modular furniture system of claim 6, wherein the reinforcing ribs are symmetrically spaced apart from one another and are parallelly disposed, and extending perpendicular between inside surfaces of the board.

8. The modular furniture system of claim 7, wherein at least some of the reinforcing ribs, together with inside faces of the board, give rise to a rectangular clamping space configured for snugly receiving at least one of: studs of a corner coupler, studs of wall couplers, studs of first partition members, and studs of second partition members.

9. (canceled)

10. The modular furniture system of claim 1, wherein at least a pair of stiffening rods parallelly extend through walls of the frame assembly, for increasing the bending stiffness thereof and for articulating the wall couplers thereto, the stiffening rods being disposed within the clamping space.

11. (canceled)

12. The modular furniture system of claim 10, wherein the stiffening rods are made of extruded material.

13. The modular furniture system of claim 12, wherein the stiffening rods have at least one articulation arrangement configured for articulating a wall coupler thereto, the articulation arrangement is configured as a coupling groove extending along at least a portion of a stiffening rod, said coupling groove configured with two arresting shoulders, facing each other, and configured for arresting a locking boss of a wall coupler.

14. (canceled)

15. The modular furniture system of claim 8, wherein articulating a side wall to a top wall and a bottom wall, respectively, is facilitated by a corner coupler comprising side wall stud projections and base wall stud projections disposed at a right angle with respect to said side wall stud projections, said side wall stud projections and base wall stud projections configured to be snugly received within clamping spaces of the boards, wherein the frame assembly is reinforced by fasteners extending through the corner coupler and into the respective side walls and base walls of the frame assembly.

16. (canceled)

17. The modular furniture system of claim 15, wherein openings at an outside surface of the corner coupler facilitate articulating a coupler element thereto, configured for attaching the furniture system to a support wall or to a neighboring furniture item.

18. The modular furniture system of claim 15, wherein the corner coupler is configured with a first face articulated to and abutting an end face of a first frame wall, and a second face articulated to and abutting an end face of a neighboring, second frame wall, said first face and said second face disposed at a right angle.

19. The modular furniture system of claim 3, wherein the wall coupler is configured for coupling ends of the at least one shelf member to the right side wall and left side wall, respectively, and ends of a partition member to a respective top wall and bottom wall, wherein the wall coupler comprises a T-shaped engaging head configured for engagement by arresting shoulders of a coupling groove of a reinforcing rod extending through a board of the frame assembly.

20. (canceled)

21. The modular furniture system of claim 19, wherein the wall coupler comprises a body portion configured for snug accommodation within a clamping space of the board and a T-shaped engaging head configured for engagement by arresting shoulders of a coupling groove of a reinforcing rod.

22. The modular furniture system of claim 1, wherein the wall couplers are configured as cylindrical projections adapted for snug fitting into an opening of a wall.

23. The modular furniture system of claim 3, wherein the partition coupler is configured for coplanar coupling at least one first partition member above a shelf member, and at least one second partition member below said shelf member.

24. The modular furniture system of claim 23, wherein the partition coupler comprises a male member and a female member coaxially couplable with one another through an intermediate board clamping portion, and wherein one of the male member and female member is configured to upright project from a first surface of a shelf member, and the other one of the male member and female member is configured to upright project from a second surface of a shelf member.

25. The modular furniture system of claim 24, wherein the male member and the female member of the partition coupler are couplable with one another by a bayonet coupling.

26. The modular furniture system of claim 25, wherein the bayonet coupling comprises a plug member extending from one of the male member and the female member and fitted with at least one laterally projecting locking lug, configured for coaxial arresting within a cup shaped portion of the other one of the male member and the female member, which is configured with an axial insertion path and arresting recesses for snapingly arresting the at least one locking lug.

27. The modular furniture system of claim 24, wherein the intermediate board clamping portion is cylindrical and has a nominal diameter corresponding with an opening extending through the at least one shelf member or the intermediate board clamping portion has a length that is slightly less than the thickness of the shelf member therebetween and applies a squeezing force normal to a surface of the shelf member.

28. (canceled)

29. The modular furniture system of claim 24, wherein one or both of the male member and the female member is configured with a fastener bore intersecting a longitudinal coupling axis of the partition coupler.

30.-47. (canceled)
